(19) United States
(12) Patent Application Publication
(10) Pub. No.: US 2014/0160907 A1
(43) Pub. Date: Jun. 12, 2014

(54) ORGANIZING FILES FOR FILE COPY

(71) Applicant: LENOVO (SINGAPORE) PTE, LTD., New Tech Park (SG)

(72) Inventors: Mark Charles Davis, Durham, NC (US); Toby John Bowen, Durham, NC (US); Howard Locker, Cary, NC (US); John Weldon Nicholson, Cary, NC (US)

(73) Assignee: LENOVO (SINGAPORE) PTE, LTD., New Tech Park (SG)

(21) Appl. No.: 13/707,302

(22) Filed: Dec. 6, 2012

(51) Int. Cl. G11B 20/12

(52) U.S. Cl. CPC G11B 20/1217
USPC 369/30.01

(57) ABSTRACT

For organizing files for file copy, an order module determines a first order for a plurality of files. The store module stores each file in the first order. File data and file metadata for the file are stored contiguously on a storage disk.

### FIELD

The subject matter disclosed herein relates to organizing files and more particularly relates to organizing files for file copy.

### BACKGROUND

### Description of the Related Art

Files such as music files are often copied to storage devices on portable devices. Copying many small files between storage devices can take significant time.

### BRIEF SUMMARY

Based on the foregoing discussion, the inventors have recognized a need for an apparatus, method, and program product that organize files for file copy. Beneficially, such an apparatus, method, and program product would facilitate rapid file copy.

The apparatus includes a computer readable storage medium, a processor, an order module, and store module. The computer readable storage medium stores machine readable code. The processor executes the machine readable code. The order module determines a first order for a plurality of files. The store module stores each file in the first order. File data and file metadata for the file are stored contiguously on a storage disk. The method and program product also perform the functions of the apparatus.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of the embodiments as set forth hereinafter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic diagram illustrating one embodiment of a storage disk organization;

FIG. 2 is a schematic block diagram illustrating one embodiment of a first order;

FIG. 3 is a schematic block diagram illustrating one embodiment of a file group first order;

FIG. 4 is a schematic block diagram illustrating one embodiment of a directory group first order;

FIG. 5 is a schematic block diagram illustrating one embodiment of a file type group first order;

FIG. 6 is a schematic block diagram illustrating one embodiment of an age category group first order;

FIGS. 7A-B are schematic block diagrams illustrating embodiments of file data and file metadata order;

FIG. 8 is a schematic block diagram illustrating one alternate embodiment of a first order;

FIG. 9 is a schematic block diagram illustrating one embodiment of a computer;

FIG. 10 is a schematic block diagram illustrating one embodiment of an organizing apparatus; and

FIG. 11 is a schematic flow chart diagram illustrating one embodiment of an organizing method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices, and may exist, at least partially, merely as electronic signals on a system or network. Where a module or portions of a module are implemented in software, the software portions are stored on one or more machine readable storage devices.

Any combination of one or more computer readable medium may be utilized. The computer readable medium may be a machine readable signal medium or a machine readable storage medium such as a computer readable storage medium. The machine readable storage medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wireline, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by machine readable code. These machine readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The machine readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The machine readable code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and machine readable code.

Descriptions of figures may refer to elements described in previous figures, like numbers referring to like elements.

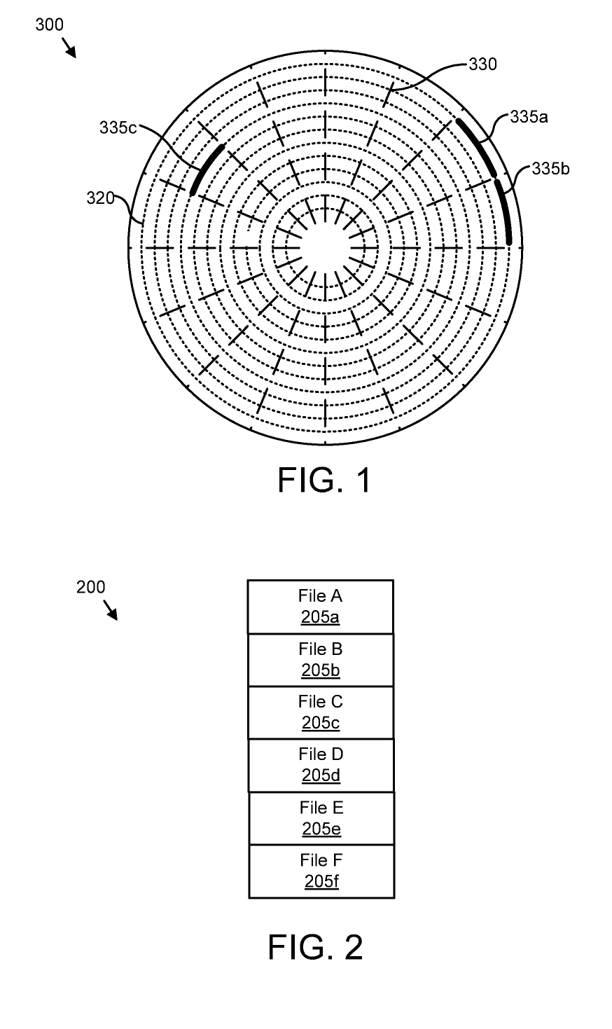

FIG. 1 is a schematic block diagram illustrating one embodiment of a storage disk organization. A storage disk 300 may be a hard disk embodied in a hard disk drive (not shown). The storage disk 300 is organized with a plurality of tracks 320. Each track 320 may have a width of one bit according to the areal density of the storage disk 300. A track 320 may be divided by multiple radii 330 into tracks sectors 335. In one embodiment, tracks sectors 335 each store a specified number of bytes such as 512 bytes or 4096 bytes. Alternatively, tracks sectors 335 may each store a variable number of bytes.

A head (not shown) may read a track sector 335 by being positioned at the beginning of the track sector 335 and radially traversing the track sector 335 while reading the magnetically encoded data. The head may then be positioned to the beginning of another track sector 335 and read that track sector 335. When tracks sectors 335 for a specified file are organized contiguously, such as for a first track sector 335a and a second track sector 335b, the tracks sectors 335 may be read rapidly. However, when a track sector 335 such as the third track sector 335c is not organized contiguously with other tracks sectors 335 in the specified file, the head must be repositioned before reading the noncontiguous track sector 335.

The repositioning of the head adds a significant delay when reading the file from the storage disk 300. This delay is multiplied many times when reading a large number of small files such as during a copy operation. The cumulative delays for repositioning the head may increase the time required for such copy operations many fold. The embodiments described herein organize files for file copy so the time required to read the files, particularly for a file copy operation, is greatly reduced as will be described hereafter.

FIG. 2 is a schematic block diagram illustrating one embodiment of a first order 200. The first order 200 is depicted as a list of files 205. The first order 200 may be an ordered list. Each file 205 may be described by a file system entry. The file system entry may list each track sector 335 storing a portion of the file 205 as well as the order of the portions. Alternatively, the file system entry may list each set of contiguous tracks sectors 335 storing a portion of the file 205 as well as in the order of the portions. In addition, the file system entry may include a filename, the modification date, a creation date, a file type, and the like. The file system entry data is often referred to as metadata. When performing operations such as the copy operations in the previous paragraph, this metadata must be retrieved in addition to the data in the file.

The first order 200 may be a list of filenames, file system entries, or the like for the files 205. In one embodiment, the first order 200 is organized as a linked list with links to the file system entries.

The first order 200 may specify in order that each file 205 in a file system, in a directory, in an age category, with a file type, or the like are to be organized on the storage disk 300 for efficient reading and copying from the storage disk 300. For example, each file 205 in the first order 200 may be stored on the storage disk 300 contiguously after a proceeding file 205 and contiguously before a following file 205. In the depicted embodiment, the files 205 of the first order 200 are arranged in the order of File A 205a, File B 205b, File C 205c, File D 205d, File E 205e, and File F 205f. When the files 205 are stored in the first order 200 on the storage disk 300, File A 205a is stored and followed contiguously by File B 205b, followed contiguously by File C 205c, followed contiguously by File D 205d, followed contiguously by File E 205e, and followed contiguously by File F 205f.

The first order 200 may be determined based on a number of factors including but not limited to groups of files, file types, directories, file age, and the like. The determination of the first order 200 will be described in more detail hereafter.

FIG. 3 is a schematic block diagram illustrating one alternate embodiment of a file group first order 200a. The first order 200 is depicted as comprising one or more file groups 215. Each file group 215 includes files 205 that satisfy specified criteria.

Each file group 215 is organized in the first order 200. Thus the files 205 of the first file group 215a, File A 205a, File B 205b, and File C 205c, are ordered contiguously followed by the files 205 of the second file group 215b, File D 205d, File E 205e, and File F 205f, which are also ordered contiguously. In addition, files 205 within each file group 215 may also be ordered contiguously.

The specified criteria may include but is not limited to inclusion within a set of files 205 managed by an application, a file type, files that are synchronized with the specified device, a file age category, the file owner, a file rating, the file modification date category, a file creator, a file artist, a file album, and the like. All files that share a specified criterion may be stored in the file group 215. Examples of file groups 215 and file group criteria will be given hereafter.

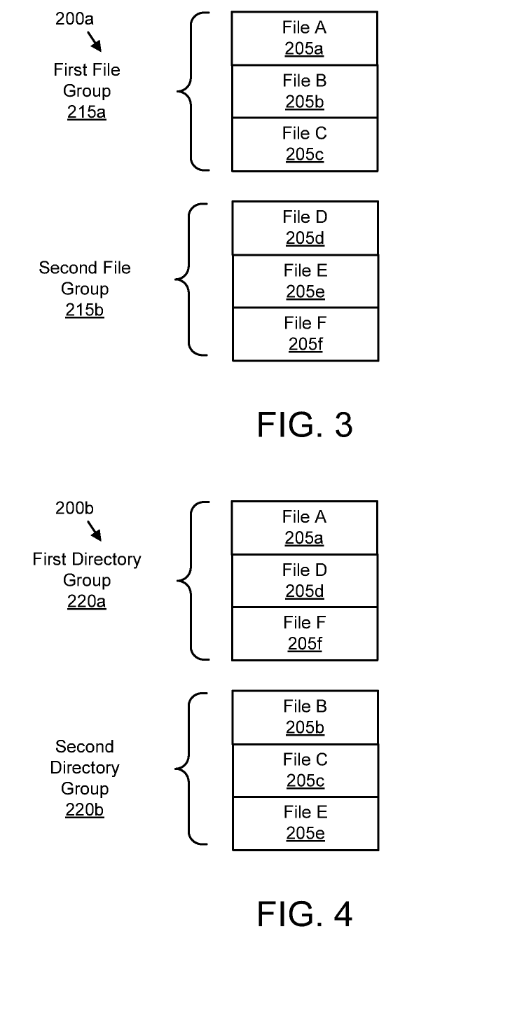

FIG. 4 is a schematic block diagram illustrating one embodiment of a directory group first order 200b. The directory group first order 200b includes one or more directory groups 220. Each directory group 220 may include files 205 within a specified directory. In one embodiment, there is directory group 220 for each directory in a file system. Alternatively, there is a directory group 220 for selected directories within the file system.

In one embodiment, the files 205 within each directory group 220 are organized alphabetically. In the depicted embodiment, File A 205a, File D 205d, and File F 205f are organized within a first directory and are included in and listed alphabetically within a first directory group 220a while File B 205b, File C 205c, and File E 205e are organized with a second directory and are included in and listed alphabetically within a second directory group 220b. Alternatively, the files 205 within each directory group 220 are organized from most recent access to least recent access. In a certain embodiment, the files 205 within each directory group 220 are organized by one or more of file rating, file size, file genre, file artist, and file album.

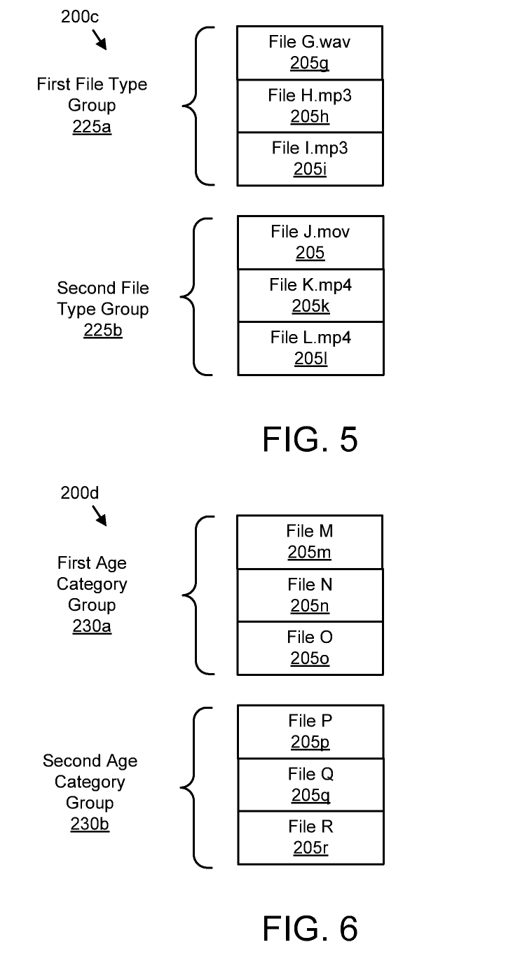

FIG. 5 is a schematic block diagram illustrating one embodiment of a file type group first order 200c. The file type group first order 200c includes one or more file type groups 225. Each file type group 225 may include files 205 of a specified file type. For example, each file type group 225 may include files 205 of the type such as audio files, a specified type of audio file, files managed by a specified application program, video files, image files, and the like. In the depicted embodiment, audio files including File G.wav 205g, File H.mp3 205h, and File I.mp3 205i are organized in a first file type group 225a while video files File J.mov 205j, File K.mp4 205k, and File L.mp4 205l are organized in a second file type group 225b.

The files 205 within each file type group 225 may be organized by one or more criteria including but not limited to alphabetically, file rating, genre, most recent access, file size, file owner, file genre, file artist, and file album. In one embodiment, files 205 are assigned to a file type group 225 regardless of the directory in which the file 205 is stored, the file owner, a file age category, or the like.

FIG. 6 is a schematic block diagram illustrating one embodiment of an age category first order 200d. The age category first order 200d includes one or more age category groups 230. Each age category group 230 may include files 205 with a creation date, a modification date, an original creation date, last access date, or the like that falls within a specified time interval. The specified time intervals may include but are not limited to a last month, the last year, a specified year, and the like. In the depicted embodiment, File M 205m, File N 205n, and File O 205o with last modification dates within the last 24 hours are organized in a first age category group 230a while File P 205p, File Q 205q, and File R 205r with last modification dates of greater than 24 hours previous are organized in a second age category group 230b.

The files 205 within each age category group 230 may be organized by one or more criteria including but not limited to alphabetically, file rating, genre, most recent access, file size, file owner, file genre, file artist, and file album. In one embodiment, files 205 are assigned to an age category group 230 regardless of the directory in which the file 205 is stored, the file type, the file owner, or the like.

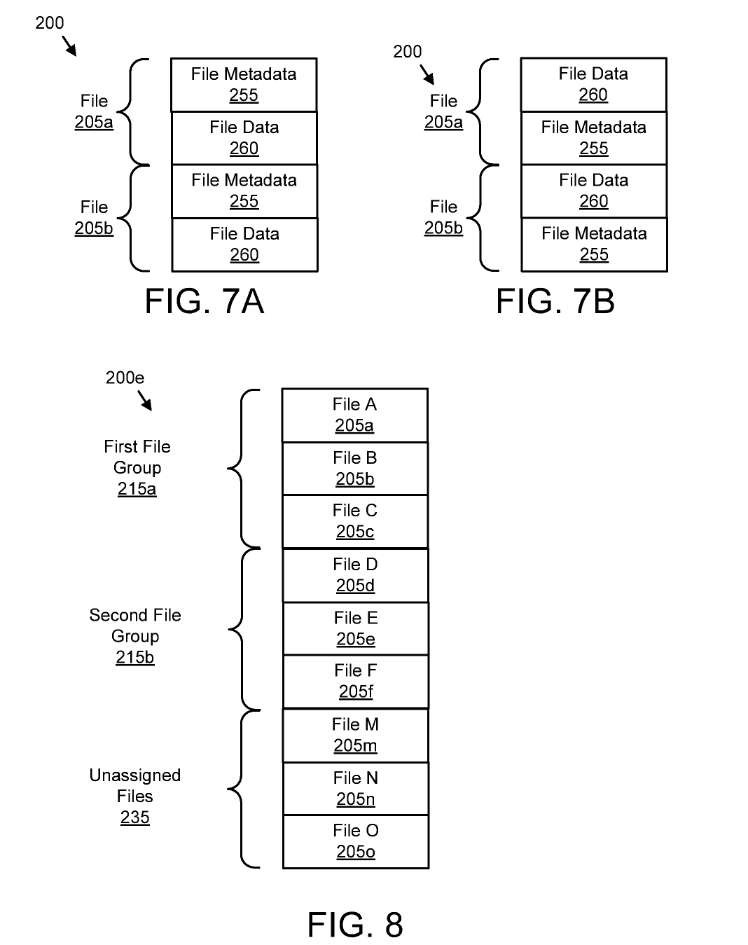

FIGS. 7A-B are schematic block diagrams illustrating embodiments of file data 260 and file metadata 255 ordered for a file 205 within the first order 200. In FIGS. 7A and 7B, a portion of a first order 200 is shown. For simplicity each portion of the first order 200 includes two files 205, although embodiments may be practiced with any number of files 205 in the first order 200. In FIG. 7A, the file metadata 255 is ordered before the file data 260. As a result, the file metadata 255 is stored on the storage disk 300 followed contiguously by the file data 260 stored on the storage disk 300. Thus when the file 205 is read from the storage disk 300, both the file metadata 255 and the file data 260 are expeditiously retrieved with a minimum of head repositioning.

Alternatively, in FIG. 7B file data 260 is ordered before file metadata 255. Thus the file data 260 is stored on the storage disk 300 followed contiguously by the file metadata 255. As a result, when the file 205 is read from the storage disk 300 260 and the file metadata 255 may be expeditiously retrieved.

In an alternate embodiment, the file data 260 may be ordered before or after the file metadata 255. The ordering of the file data 260 and the file metadata 255 may be selected to optimize the organization of the file 205 on the storage disk 300.

In one embodiment, files 205 are stored contiguously on the storage disk 300 if an end of a first file 205a is stored in an adjacent track sector 335 of a same track 320 to a track sector 335 storing the start of a second file 205b. Similarly, the file metadata 255 is stored contiguously to the file data 260 if the file metadata 255 is stored in a track sector 335 adjacent to a track sector 335 of the file data 260.

FIG. 8 is a schematic block diagram illustrating one alternate embodiment of a first order 200e. In the depicted embodiment, the first order 200e is arranged as an order of file groups 215. For example, the first file group 215a may comprise files 205 that are regularly synchronized such as files 205 that are regularly synchronized to a cloud drive. The second file group 215b may include music files. Additional file groups 215 may also have a place in the first order 200e.

In one embodiment, some files 205 may not be assigned to a file group 215. The files 205 not assigned to a file group 215 may be ordered within the first order 200e as unassigned files 235. In the depicted embodiment, File A 205a, File B 205b, and File C 205c are organized in the first file group 215a, File D 205d, File E 205e, and File F 205f are organized in the second file group 215b, while File M 205m, File N 205n, and File O 205o included in the first order 200e as unassigned files 235. Alternatively, the unassigned files 235 may be excluded from the first order 200e. In one embodiment, the file data 260 and the file metadata 255 of the unassigned files 235 are not ordered contiguously. Alternatively, the file data 260 and the file metadata 255 of the unassigned files 235 are ordered contiguously.

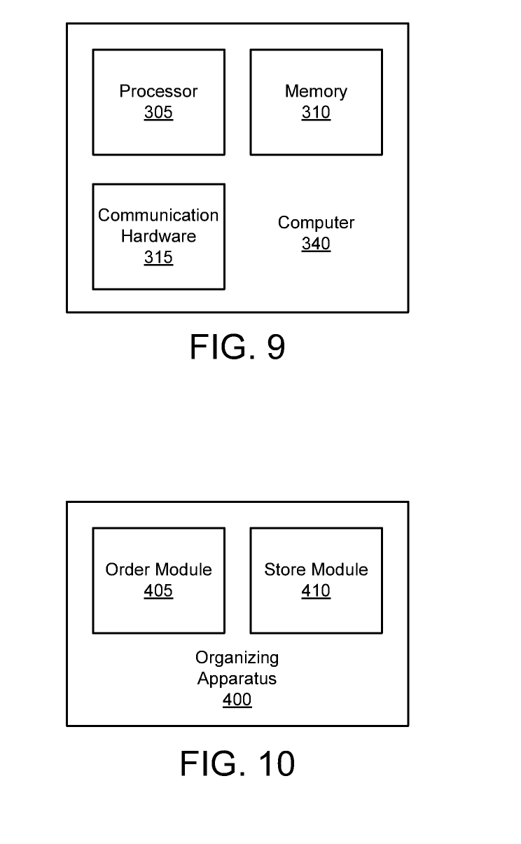

FIG. 9 is a schematic block diagram illustrating one embodiment of a computer 340. The computer 340 may be a controller for the storage disk 300. Alternatively, the computer 340 may be a host computer storing files 205 to and reading files 205 from the hard disk drive of the storage disk 300.

The computer 340 may include a processor 305, a memory 310, and communication hardware 315. The memory 310 may be a computer readable storage medium such as a semiconductor storage device, a hard disk drive, a holographic storage device, a micromechanical storage device, or the like. The memory 310 may store machine readable code. The processor 305 may execute the machine readable code. The communication hardware 315 may communicate with other devices.

FIG. 10 is a schematic block diagram illustrating one embodiment of an organizing apparatus 400. The apparatus 400 may be embodied in the computer 340. Alternatively, the apparatus 400 may be embodied in one or more computers 340 such as a hard disk drive controller and/or a host computer. The memory 310 may store the file order 200.

The apparatus includes an order module 405 and a store module 410. The order module 405 and the store module 410 may each be embodied in a computer readable storage medium. The computer readable storage medium may be the memory 310. The computer readable storage medium may store machine readable code that when executed by the processor 305 performs the functions of the order module 405 and the store module 410.

The order module 405 may determine the first order 200 for the plurality of files the store module 410 may store each file 205 contiguously with file metadata 255 for the file 205 in the first order on the storage disk 300.

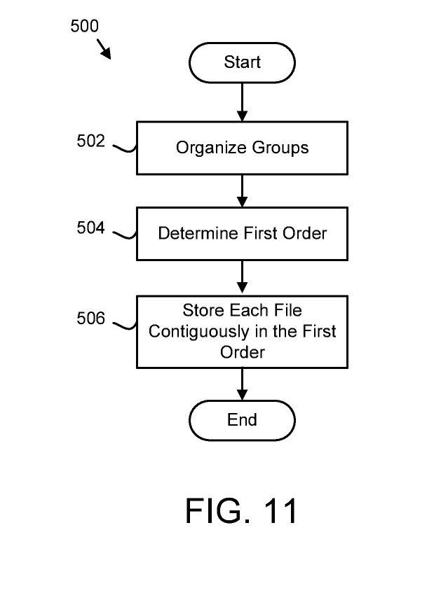

FIG. 11 is a schematic flow chart diagram illustrating one embodiment of an organizing method 500. The method 500 may perform the functions of the apparatus 400. In one embodiment, the method 500 is performed by a computer readable storage medium such as the memory 310 storing machine readable code. The processor 305 may execute the machine readable code to perform the functions of the method 500.

The method 500 starts, and in one embodiment the order module 405 organizes 502 file groups 215 of a plurality of files 205 stored on the storage disk 300. The order module 405 may organize 502 file groups 215 as directory groups 220, file type groups 225, and/or age category groups 230. Alternatively, the order module 405 may organize 502 the file groups 215 using specified criteria. In one embodiment, the specified criterion is the organization and/or management of the files 205 by a specified application program. For example, all files 205 organized by a music player application program maybe organized into a file group 215 such as a file type group 225.

In one embodiment, the order module 405 organizes 502 the file groups 215 as a background operation. Alternatively, the file groups 215 maybe organized 502 while the storage disk 300 is idle. In a certain embodiment, the order module 405 organizes 502 the file groups 215 during a storage disk defragmentation. In one embodiment, the order module 405 organizes 502 a file 205 into a file group 215 each time a file 205 is originally stored to the storage disk 300.

In one embodiment, the order module 405 organizes 502 all files 205 within a file system into one or more file groups 215. Alternatively, some files 205 may not be assigned to a file group 215. For example, system files, application programs, configuration files, and the like may not be assigned to a file group 215 but instead may be unassigned files 235.

The order module 405 may further determine 504 a first order 200 for the plurality of files 205. In one embodiment, the first order 200 is organized as first an order of file groups 215 and second as an order of files 205 within the file groups 215. For example, the file group 215 of files 205 that are synchronized to a cloud drive may be ordered first, followed by the file group 215 of music files 205.

The order module 405 may further determine 504 the first order 200 within each file group 215. For example, files 205 within the file group 215 may be ordered by modification date, file size, file owner, file artist, file album, and the like.

Alternatively, the first order 200 may be determined 504 without regard to file groups 215. For example, all files 205 in a file system may be ordered in the first order 200 by modification date, from most recently modified to least recently modified. One of skill in the art will recognize that other criterion may be applied to order the files 205.

In one embodiment, the order module 405 may determine 504 the first order 200 as a background operation. Alternatively, the first order 200 may be determined 504 while the storage disk 300 is idle. In one embodiment, the order module 405 determines 504 the first order 200 each time a file 205 is originally stored to the storage disk 300. In a certain embodiment, the order module 405 determines 504 the first order 200 during a storage disk defragmentation.

The store module 410 may store 506 each file 205 in the first order 200, with the file data 260 and file metadata stored contiguously on the storage disk 300 and the method 500 ends. In one embodiment, the store module 410 stores 506 each file 205 in the first order 200 as the file 205 is originally stored to the storage disk 300. Alternatively, the store module 410 may store 506 each file 205 in the first order 200 on the storage disk 300 during a storage disk defragmentation.

By determining 504 the first order 200 for the plurality of files 205 and storing 506 the file metadata 255 and the file data 260 of the file 205 contiguously in the first order 200 on the storage disk 300, the apparatus 400 and method 500 organize the files 205 to be quickly copied from the storage disk 300. As a result, copies of the files 205 to another storage device such as the media player and/or cloud drive are performed quickly and efficiently.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a computer readable storage medium storing machine readable code;
a processor executing the machine readable code, the machine readable code comprising:
an order module determining a first order for a plurality of files; and
a store module storing each file in the first order, wherein file data and file metadata for the file are stored contiguously on a storage disk.

2. The apparatus of claim 1, the order module further organizing groups of the plurality of files.

3. The apparatus of claim 2, wherein the first order comprises arranging files within a same group contiguously.

4. The apparatus of claim 3, wherein each group is a file type.

5. The apparatus of claim 3, wherein each group is a directory.

6. A method comprising:
determining, by use of a processor, a first order for a plurality of files; and
storing each file in the first order, wherein file data and file metadata for the file are stored contiguously on a storage disk.

7. The method of claim 6, further comprising organizing groups of the plurality of files.

8. The method of claim 7, wherein the first order comprises arranging files within a same group contiguously.

9. The method of claim 8, wherein each group is a file type.

10. The method of claim 8, wherein each group is a directory.

11. The method of claim 8, wherein each group is an age category.

12. The method of claim 6, wherein contiguous data is stored in adjacent track sectors.

13. The method of claim 6, wherein each file is originally stored with the file data and the file metadata for the file in the first order.

14. The method of claim 6, wherein each file is stored with the file data and the file metadata for the file in the first order in response to a storage disk defragmentation.

15. The method of claim 6, wherein each file is stored with the file data and the file metadata for the file in the first order in response to an idle disk.

16. A program product comprising a computer readable storage medium storing machine readable code executed by a processor to perform the operations of:
determining a first order for a plurality of files; and
storing each file in the first order, wherein file data and file metadata for the file are stored contiguously on a storage disk.

17. The program product of claim 16, further comprising organizing groups of the plurality of files.

18. The program product of claim 17, wherein the first order comprises arranging files within a same group contiguously.

19. The program product of claim 18, wherein each group is a file type.

20. The program product of claim 18, wherein each group is a directory.
